(19) United States
(12) Patent Application Publication
(10) Pub. No.: US 2022/0141477 A1
(43) Pub. Date: May 5, 2022

(54) IMAGE PROCESSING APPARATUS AND IMAGE PROCESSING METHOD

(71) Applicant: SONY GROUP CORPORATION, Tokyo (JP)

(72) Inventor: Jongdae KIM, Tokyo (JP)

(73) Assignee: SONY GROUP CORPORATION, Tokyo (JP)

(21) Appl. No.: 17/427,812

(22) PCT Filed: Dec. 6, 2019
(86) PCT No.: PCT/JP2019/047831

§ 371 Date: Aug. 2, 2021

(30) Foreign Application Priority Data
Feb. 21, 2019 (JP) 2019-029419

(51) Int. Cl. H04N 19/423; H04N 19/593; H04N 19/119; H04N 19/86; H04N 19/80; H04N 19/136

(52) U.S. Cl. CPC H04N 19/423; H04N 19/593; H04N 19/136; H04N 19/86; H04N 19/80; H04N 19/119

(57) ABSTRACT

A line buffer number calculation unit 38 calculates a number of line buffers on the basis of level information and input image information. For example, the line buffer number calculation unit 38 uses a maximum screen horizontal size calculated on the basis of a maximum number of in-screen pixels corresponding to a level indicated by the level information, and uses an input image horizontal size indicated by input image information, to calculate the number of line buffers. An intra-prediction unit 41 performs intra-prediction processing by using a line buffer of the number of line buffers calculated by the line buffer number calculation unit 38. In a case where a horizontal size of an input image is small with respect to the level indicating processing capabilities, intra-prediction can be performed using a reference image stored in a line buffer of the number of line buffers, and coding efficiency can be improved by effectively using the line buffer.

### TECHNICAL FIELD

The present technology relates to an image processing apparatus and an image processing method, and enables improvement of coding efficiency.

### BACKGROUND ART

The international telecommunication union telecommunication standardization sector (ITU-T) has been proposing a variety of video coding in the joint video exploration team (JVET), which is developing next-generation video coding.

In video coding, in intra-prediction, a code amount of pixel information is reduced by utilizing a correlation between adjacent blocks in the same frame. For example, in H.264/AVC, in addition to plane prediction and DC prediction, directional prediction corresponding to nine prediction directions can be selected as an intra-prediction mode. Furthermore, in H.265/HEVC, in addition to plane prediction and DC prediction, angular prediction corresponding to 33 prediction directions can be selected as an intra-prediction mode.

Furthermore, in standardization of an image coding method called versatile video coding (VVC), as shown in Non Patent Document 1, an intra-prediction (multiple reference line intra-prediction) using multiple lines around a coding target block has been proposed. Furthermore, Non Patent Document 2 proposes a restriction that multiple lines are not used at a coding tree unit (CTU) boundary.

### CITATION LIST

### Non Patent Document

Non Patent Document 1: B. Bross, J. Chen, S. Liu, “Versatile Video Coding (Draft 3),” document JVET-L1001, 12th JVET meeting: Macao, CN, 3-12, Oct. 2018
Non Patent Document 2: B. Bross, L. Zhao, Y. J. Chang, P. H. Lin, “CE3: Multiple reference line intra prediction,” document JVET-L0283, 12th JVET meeting: Macao, CN, 3-12, Oct. 2018

### SUMMARY OF THE INVENTION

### Problems to be Solved by the Invention

Meanwhile, as shown in Non Patent Document 2, a line buffer used at a maximum image frame can be suppressed by setting the restriction that multiple lines are not used at the coding tree unit (CTU) boundary. However, when it is not the maximum image frame, resources of the line buffer cannot be used up and the line buffer cannot be used efficiently.

Therefore, it is an object of the present technology to provide an image processing apparatus and an image processing method capable of improving coding efficiency.

### Solutions to Problems

A first aspect of the present technology is an image processing apparatus including:

a line buffer number calculation unit configured to calculate a number of line buffers on the basis of level information and input image information; and

an intra-prediction unit configured to perform intra-prediction processing by using a line buffer of a number of line buffers calculated by the line buffer number calculation unit.

In the present technology, the line buffer number calculation unit calculates the number of line buffers on the basis of level information and input image information. For example, the line buffer number calculation unit may calculate the number of line buffers by using a maximum screen horizontal size calculated on the basis of a maximum number of in-screen pixels corresponding to a level indicated by the level information, and using an input image horizontal size indicated by the input image information, and may calculate the number of line buffers by using a maximum screen horizontal size stored in advance instead of the input image information.

The intra-prediction unit performs the intra-prediction processing by using a line buffer of the number of line buffers calculated by the line buffer number calculation unit. By using a prediction result of this intra-prediction unit, a coded stream is generated, and the coded stream includes level information and input image information. Furthermore, the coded stream may include identification information that enables identification as to whether it is intra-prediction processing using a line buffer of the calculated number of line buffers or intra-prediction processing using a line buffer of one line. Furthermore, in a case where the intra-prediction unit performs downsampling processing on a luminance component in cross-component linear model prediction, it is possible to adopt a number of filter taps according to the number of line buffers calculated by the line buffer number calculation unit.

Furthermore, for tile division, the number of line buffers may be calculated by the line buffer number calculation unit by using a tile horizontal size. Further, a deblocking filter configured to perform deblocking filter processing on decoded image data may perform the deblocking filter processing with the number of filter taps according to the calculated number of line buffers, by using a line buffer of the number of line buffers calculated by the line buffer number calculation unit.

At a time of coding an input image, when the intra-prediction unit performs intra-prediction for a line at the CTU boundary, the intra-prediction unit uses decoded image data held in a line buffer of the calculated number of line buffers to determine an optimum intra-prediction mode. Furthermore, at a time of decoding the coded stream, the intra-prediction unit uses decoded image data held in line a buffer of the calculated number of line buffers, to generate a prediction image in the optimum intra-prediction mode indicated by the coded stream.

A second aspect of the present technology is an image processing method including:

calculating, by a line buffer number calculation unit, a number of line buffers on the basis of level information and input image information; and

performing, by an intra-prediction unit, intra-prediction processing by using a line buffer of a number of line buffers calculated by the line buffer number calculation unit.

### BRIEF DESCRIPTION OF DRAWINGS

FIG. 1 is a view showing a relationship between a luminance reference pixel line index of a luminance component and a reference pixel line.

FIG. 2 is a diagram illustrating a configuration of an image coding apparatus.

FIG. 3 is a diagram illustrating a configuration of an intra-prediction unit.

FIG. 4 is a diagram illustrating a configuration of an intra-mode search unit.

FIG. 5 is a diagram illustrating a configuration of a prediction image generation unit.

FIG. 6 is a flowchart illustrating a coding processing operation of the image coding apparatus.

FIG. 7 is a flowchart illustrating intra-prediction processing.

FIG. 8 is a flowchart showing a first operation of a line buffer number calculation unit.

FIG. 9 is a view showing a relationship between a level (Level) and a maximum luminance picture size (MaxLumaPs).

FIG. 10 is a view showing a relationship between a level and a maximum screen horizontal size (max_pic_width).

FIG. 11 is a view showing a relationship between an input image and a number of intra-prediction line buffers.

FIG. 12 is a view illustrating a line buffer that can be used for intra-prediction.

FIG. 13 is a view illustrating a reference pixel line in intra-prediction.

FIG. 14 is a view illustrating syntax of a coding unit.

FIG. 15 is a view showing a relationship between a level and a maximum horizontal size (MaxW).

FIG. 16 is a view illustrating a line buffer that can be used for intra-prediction.

FIG. 17 is a view illustrating a part of syntax of a sequence parameter set.

FIG. 18 is a view showing a luminance component (Luma) and a corresponding color difference component (Chroma).

FIG. 19 is a view illustrating a downsampling method.

FIG. 20 is a view showing a case of performing filtering of three taps in a horizontal direction to calculate a prediction value, which is a luminance component at a pixel position common to a color difference component.

FIG. 21 is a view showing a case where a maximum number of line buffers (MaxLumaRefNum) is 2 or more.

FIG. 22 is a diagram illustrating a configuration of an image decoding apparatus.

FIG. 23 is a flowchart illustrating an operation of the image decoding apparatus.

FIG. 24 is a flowchart showing an operation of the image coding apparatus.

FIG. 25 is a view illustrating syntax of a coding unit.

FIG. 26 is a flowchart showing an operation of the image decoding apparatus.

### MODE FOR CARRYING OUT THE INVENTION

<Documents and the Like that Support Technical Contents and Technical Terms>

The scope disclosed in the present technology includes not only the contents described in the embodiment, but also the contents described in the following non patent documents known at the time of filing of the application.
Non Patent Document 3: Jianle Chen, Elena Alshina, Gary J. Sullivan, Jens-Rainer, JillBoyce, “Algorithm Description of Joint Exploration Test Model 4”, JVET-G1001_v1, Joint Video Exploration Team (WVET) of ITU-T SG 16 WP 3 and ISO/IEC JTC 1/SC 29/WG 11 7th Meeting: Torino, IT, 13-21, July 2017
Non Patent Document 4: TELECOMMUNICATION STANDARDIZATION SECTOR OF ITU (International Telecommunication Union), “High efficiency video coding”, H.265, December 2016
Non Patent Document 5: TELECOMMUNICATION STANDARDIZATION SECTOR OF ITU (International Telecommunication Union), “Advanced video coding for generic audiovisual services”, H.264, April 2017

That is, the contents described in Non Patent Documents 1 to 5 are also the basis for determining support requirements. Furthermore, similarly, technical terms such as parsing, syntax, and semantics, for example, are to be within the scope of the disclosure of the present technology and satisfy the support requirements of the claims, even in a case where there is no direct description thereof in the embodiment.

<Terms>

In the present application, the following terms are defined as follows.

<Block>

“Block” (that is not a block indicating a processing part) used for description as a partial region or a unit of processing of an image (a picture) indicates any partial region in the picture unless otherwise specified, and a size, a shape, characteristics, and the like are not limited. For example, “block” is to include any partial region (a unit of processing) such as a transform block (TB), a transform unit (TU), a prediction block (PB), a prediction unit (PU), a smallest coding unit (SCU), a coding unit (CU), a largest coding unit (LCU), a coding tree block (CTB), a coding tree unit (CTU), a transform block, a sub-block, a macro block, a tile, or a slice.

<Specification of Block Size>

Furthermore, in specifying a size of such a block, it is also possible to indirectly specify the block size in addition to directly specifying the block size. For example, the block size may be specified with use of identification information for identifying the size. Furthermore, for example, the block size may be specified with a ratio with or a difference from a size of a reference block (for example, an LCU, an SCU, or the like). For example, in a case of transmitting information for specifying the block size as a syntax element or the like, the information for indirectly specifying the size as described above may be used as the information. By doing like this, an information amount of the information can be reduced, and coding efficiency may also be improved in some cases. Furthermore, the specification of the block size also includes specification of a range of the block size (for example, specification of a range of allowable block sizes, and the like).

<Unit of Information/Processing>

Any unit of data in which various kinds of information are set and any unit of data targeted by various processes may be individually adopted. For example, these pieces of information and processing may be individually set for each transform unit (TU), transform block (TB), prediction unit (PU), prediction block (PB), coding unit (CU), largest coding unit (LCU), sub-block, block, tile, slice, picture, sequence, or component, or may target data of those units of data. Of course, this unit of data may be set for each piece of information and processing, and it is not necessary that units of data of all information and processing are unified. Note that these pieces of information may be stored at any place, and may be stored in a header, a parameter set, and the like of the above-described unit of data. Furthermore, these pieces of information may be stored at a plurality of locations.

<Control Information>

Control information related to the present technology may be transmitted from a coding side to a decoding side. For example, it is possible to transmit, as control information, level information regarding coding performance, input image information regarding input images, a block size (upper and lower limits, or both), and information that specifies a frame, a component, a layer, or the like.

<Flag>

Note that, in this specification, “flag” is information for identifying a plurality of states, and includes not only information to be used for identifying two states of true (1) or false (0), but also information that enables identification of three or more states. Therefore, a value that can be taken by the “flag” may be, for example, a binary value of 1/0, or may be a ternary value or more. That is, the number of bits included in the “flag” can take any number, and may be 1 bit or a plurality of bits. Furthermore, for the identification information (including the flag), in addition to a form in which the identification information is included in a bitstream, a form is assumed in which difference information of the identification information with respect to a certain reference information is included in the bitstream. Therefore, in this specification, the “flag” and the “identification information” include not only the information thereof but also the difference information with respect to the reference information.

<Associating Metadata>

Furthermore, various kinds of information (such as metadata) related to coded data (a bitstream) may be transmitted or recorded in any form as long as it is associated with the coded data. Here, the term “associating” means, when processing one data, allowing other data to be used (to be linked), for example. That is, the data associated with each other may be combined as one data or may be individual data. For example, information associated with coded data (an image) may be transmitted on a transmission line different from the coded data (the image). Furthermore, for example, information associated with the coded data (the image) may be recorded on a recording medium different from the coded data (the image) (or another recording region of the same recording medium). Note that this “association” may be for a part of the data, rather than the entire data. For example, an image and information corresponding to the image may be associated with each other in any unit such as a plurality of frames, one frame, or a part within a frame.

Note that, in the present specification, a term such as “including” means combining a plurality of things into one, such as, for example, combining coded data and metadata into one data, and means one method of “associating” described above. Furthermore, in the present specification, coding includes not only the entire process of transforming an image into a bitstream but also a part of the process. For example, in addition to a process including prediction processing, orthogonal transformation, quantization, arithmetic coding, and the like, a process collectively refers to quantization and arithmetic coding, a process including prediction processing, quantization, and arithmetic coding, and the like are also included. Similarly, decoding includes not only the entire process of transforming a bitstream into an image, but also a part of the process. For example, in addition to a process including inverse arithmetic decoding, inverse quantization, inverse orthogonal transformation, prediction processing, and the like, a process including inverse arithmetic decoding and inverse quantization, a process including inverse arithmetic decoding, inverse quantization, and prediction processing, and the like are also included.

<About Present Technology>

Hereinafter, an embodiment for implementing the present technology will be described. Note that the description will be given in the following order.

1. About intra-prediction in which multiple lines can be used

2. About image coding processing
2-1. Configuration of image coding apparatus
2-2. Operation of image coding apparatus
   2-2-1. First operation of line buffer number calculation unit
   2-2-2. Second operation of line buffer number calculation unit
   2-2-3. Other operations of intra-prediction unit
   2-2-4. Deblocking filter processing operation
   2-2-5. Operation at tile division

3. About image decoding processing
3-1. Configuration of image decoding apparatus
3-2. Operation of image decoding apparatus

4. Other operations of image processing apparatus

5. Application example

### 1. About Intra-Prediction in which Multiple Lines can be Used

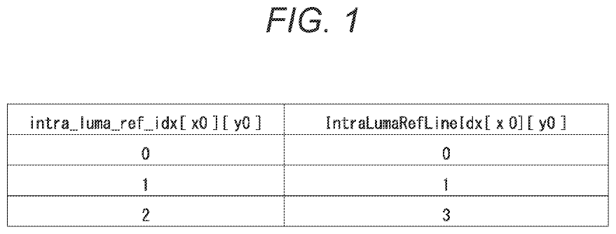

In intra-prediction in which multiple lines can be used, an index (a reference line index) indicating a reference pixel line is used to determine which line in the multiple lines is used for intra-prediction. FIG. 1 shows a relationship between a luminance reference pixel line index of a luminance component and a reference pixel line. When the luminance reference pixel line index (intra_luma_ref_idx [x0] [y0]) is “1”, an adjacent line (IntraLumaRefLineIdx [x0] [y0]=1) is to be a reference pixel line for direction prediction. When the luminance reference pixel line index (intra_luma_ref_idx [x0] [y0]) is “2”, the third line from a boundary (IntraLumaRefLineIdx [x0] [y0]=3) is to be a reference pixel line for direction prediction. Furthermore, when the luminance reference pixel line index (intra_luma_ref_idx [x0] [y0]) is other than “0”, plane prediction and DC prediction are restricted not to be used. In such intra-prediction in which multiple lines can be used, the present technology efficiently utilizes resources of a line buffer to improve the coding efficiency.

### 2. About Image Coding

Next, a description is given to a case where an image processing apparatus of the present technology performs coding processing of an input image to generate a coded stream.

<2-1. Configuration of Image Coding Apparatus>

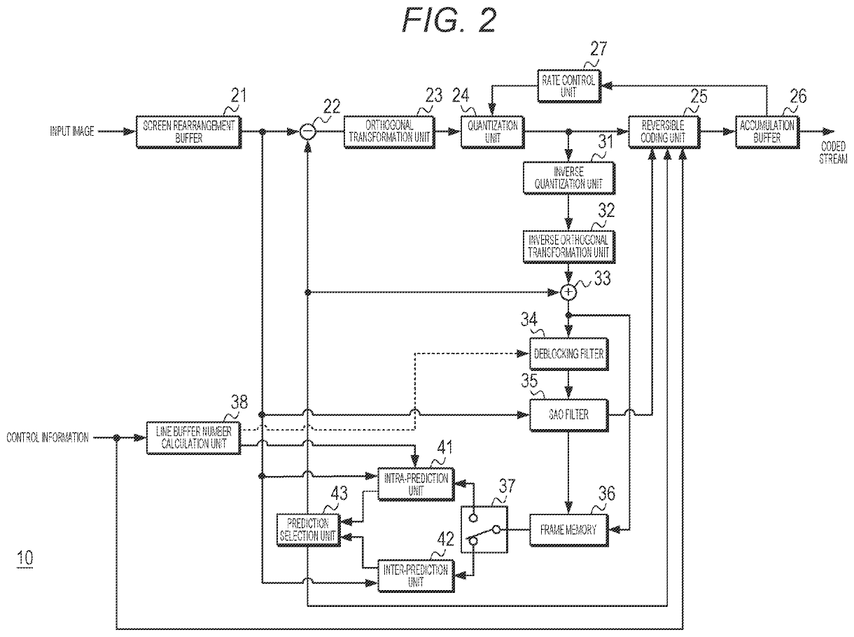

FIG. 2 illustrates a configuration of an image coding apparatus that uses multiple lines for intra-prediction. An image coding apparatus 10 includes a screen rearrangement buffer 21, an arithmetic unit 22, an orthogonal transformation unit 23, a quantization unit 24, a reversible coding unit 25, an accumulation buffer 26, and a rate control unit 27. Furthermore, the image coding apparatus 10 has an inverse quantization unit 31, an inverse orthogonal transformation unit 32, an arithmetic unit 33, a deblocking filter 34, a sample adaptive offset (SAO) filter 35, a frame memory 36, and a selection unit 37. Moreover, the image coding apparatus 10 includes a line buffer number calculation unit 38, an intra-prediction unit 41, an inter-prediction unit 42, and a prediction selection unit 43.

An input image is inputted to the screen rearrangement buffer 21. The screen rearrangement buffer 21 stores input images and rearranges stored frame images in a display order into an order for coding (a coding order) in accordance with a group of picture (GOP) structure. The screen rearrangement buffer 21 outputs image data (original image data) of the frame images in the coding order, to the arithmetic unit 22. Furthermore, the screen rearrangement buffer 21 outputs the original image data to the SAO filter 35, the intra-prediction unit 41, and the inter-prediction unit 42.

The arithmetic unit 22 subtracts, from the original image data supplied from the screen rearrangement buffer 21, prediction image data supplied from the intra-prediction unit 41 or the inter-prediction unit 42 via the prediction selection unit 43 for each pixel, and outputs residual data indicating a prediction residual to the orthogonal transformation unit 23.

For example, in a case of an image to be subjected to intra-coding, the arithmetic unit 22 subtracts prediction image data generated by the intra-prediction unit 41 from the original image data. Furthermore, for example, in a case of an image to be subjected to inter-coding, the arithmetic unit 22 subtracts prediction image data generated by the inter-prediction unit 42 from the original image data.

The orthogonal transformation unit 23 performs orthogonal transformation processing on the residual data supplied from the arithmetic unit 22. For example, the orthogonal transformation unit 23 performs orthogonal transformation such as discrete cosine transformation, discrete sine transformation, or Karhunen-Loeve transformation for each of one or more TUs set in each coding tree unit (CTU). The orthogonal transformation unit 23 outputs a transform coefficient of a frequency domain obtained by performing the orthogonal transformation processing, to the quantization unit 24.

The quantization unit 24 quantizes the transform coefficient outputted by the orthogonal transformation unit 23. The quantization unit 24 outputs quantization data of the transform coefficient to the reversible coding unit 25. Furthermore, the quantization unit 24 outputs the generated quantization data to the inverse quantization unit 31.

The reversible coding unit 25 performs reversible coding processing on the quantization data inputted from the quantization unit 24 for each CTU. Furthermore, the reversible coding unit 25 acquires information regarding a prediction mode selected by the prediction selection unit 43, such as, for example, intra-prediction information and inter-prediction information. Moreover, the reversible coding unit 25 acquires filter information related to filter processing from the SAO filter 35 described later. Moreover, the reversible coding unit 25 acquires block information indicating how CTU, CU, TU, and PU should be set in an image. The reversible coding unit 25 codes the quantization data, and also accumulates acquired parameter information related to the coding processing in the accumulation buffer 26 as a part of header information of the coded stream, as a syntax element of the H.265/HEVC standard. Furthermore, the reversible coding unit 25 includes, into the coded stream as a syntax element of the coded stream, control information (for example, level information and input image information described later) inputted to the image coding apparatus 10.

The accumulation buffer 26 temporarily holds the data supplied from the reversible coding unit 25, and outputs, as a coded stream, to a recording device (not shown) in a subsequent stage or a transmission line at a predetermined timing, for example, as a coded image that has been coded.

The rate control unit 27 controls a rate of quantization operation of the quantization unit 24 on the basis of compressed images accumulated in the accumulation buffer 26 so as not to cause overflow or underflow.

The inverse quantization unit 31 inversely quantizes quantization data of the transform coefficient supplied from the quantization unit 24, by a method corresponding to the quantization performed by the quantization unit 24. The inverse quantization unit 31 outputs the obtained inverse quantization data to the inverse orthogonal transformation unit 32.

The inverse orthogonal transformation unit 32 performs inverse orthogonal transformation of the supplied inverse quantization data by a method corresponding to the orthogonal transformation processing performed by the orthogonal transformation unit 23. The inverse orthogonal transformation unit 32 outputs an inverse orthogonal transformation result, that is, restored residual data, to the arithmetic unit 33.

The arithmetic unit 33 adds, to the residual data supplied from the inverse orthogonal transformation unit 32, prediction image data supplied from the intra-prediction unit 41 or the inter-prediction unit 42 via the prediction selection unit 43, to obtain a locally decoded image (a decoded image). For example, in a case where the residual data corresponds to an image to be subjected to intra-coding, the arithmetic unit 33 adds the prediction image data supplied from the intra-prediction unit 41 to the residual data. Furthermore, for example, in a case where the residual data corresponds to an image to be subjected to inter-coding, the arithmetic unit 33 adds the prediction image data supplied from the inter-prediction unit 42 to the residual data. The decoded image data that is an addition result is outputted to the deblocking filter 34. Furthermore, the decoded image data is outputted to the frame memory 36.

The deblocking filter 34 removes block distortion of decoded image data by appropriately performing deblocking filter processing. The deblocking filter 34 outputs a filter processing result to the SAO filter 35.

The SAO filter 35 performs adaptive offset filter processing (also referred to as sample adaptive offset (SAO) processing) on the decoded image data filtered by the deblocking filter 34. The SAO filter 35 outputs the image after SAO processing to the frame memory 36.

The decoded image data accumulated in the frame memory 36 is outputted to the intra-prediction unit 41 or the inter-prediction unit 42 via the selection unit 37 at a predetermined timing. For example, in a case of an image to be subjected to intra-coding, the decoded image data that has not been subjected to the filter processing by the deblocking filter 34 or the like is read from the frame memory 36 and outputted to the intra-prediction unit 41 via the selection unit 37. Furthermore, for example, in a case where inter-coding is performed, the decoded image data that has been subjected to the filter processing by the deblocking filter 34 or the like is read from the frame memory 36 and outputted to the inter-prediction unit 42 via the selection unit 37.

The line buffer number calculation unit 38 calculates a maximum number of line buffers (MaxLumaRefNum) used for intra-prediction, on the basis of inputted control information, or on the basis of control information and information stored in advance, and outputs to the intra-prediction unit 41. Furthermore, the line buffer number calculation unit 38 may calculate the calculated maximum number of line buffers (MaxLineBufNum), and output to the deblocking filter 34.

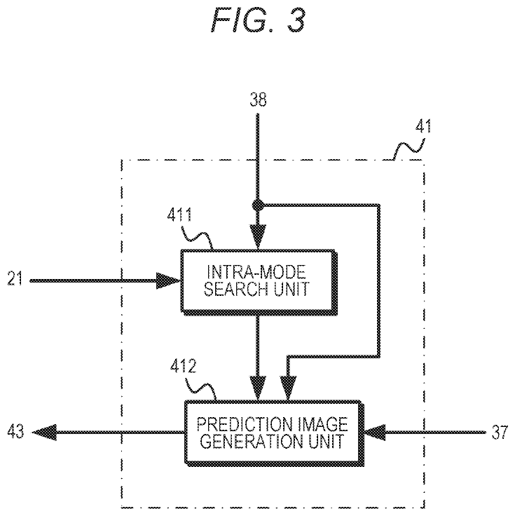

The intra-prediction unit 41 performs intra-prediction on the basis of a predetermined intra-prediction mode table, by using line buffers of the maximum number of line buffers (MaxLumaRefNum). FIG. 3 illustrates a configuration of the intra-prediction unit. The intra-prediction unit 41 has an intra-mode search unit 411 and a prediction image generation unit 412.

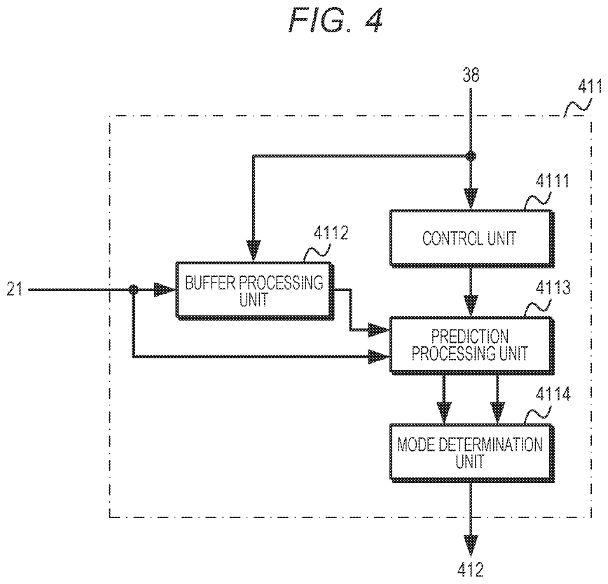

The intra-mode search unit 411 searches for an optimum intra-mode. FIG. 4 illustrates a configuration of the intra-mode search unit. The intra-mode search unit has a control unit 4111, a buffer processing unit 4112, a prediction processing unit 4113, and a mode determination unit 4114.

The control unit 4111 sets a search range of intra-prediction on the basis of the maximum number of line buffers MaxLumaRefNum calculated by the line buffer number calculation unit 38. For example, in a case where the maximum number of line buffers MaxLumaRefNum is “1”, the search range is set to an adjacent line. In a case where the maximum number of line buffers MaxLumaRefNum is “2”, the search range is set to a line separated from the adjacent line by one line. The control unit 4111 outputs the search range to the prediction processing unit 4113.

The buffer processing unit 4112 holds original image data supplied from the screen rearrangement buffer 21 by using line buffers of the maximum number of line buffers calculated by the line buffer number calculation unit 38, and outputs the held image data to the prediction processing unit 4113 as reference image data for intra-prediction.

The prediction processing unit 4113 uses the original image data supplied from the screen rearrangement buffer 21 and the reference image data supplied from the buffer processing unit 4112, to calculate a cost function value for each prediction mode for the search range indicated by the control unit 4111. The control unit 4111 outputs the calculated cost function value for each prediction mode to the mode determination unit 4114.

From the cost function value for each prediction mode, the mode determination unit 4114 sets, as an optimum prediction mode, a combination of a prediction block size and a prediction mode in which the cost function value is the smallest, that is, an intra-prediction mode in which a compression ratio is the highest. The mode determination unit 4114 outputs a mode determination result indicating the optimum prediction mode to the prediction image generation unit 412.

The prediction image generation unit 412 uses the optimum prediction mode determined by the mode determination unit 4114 of the intra-mode search unit 411 and the decoded image data read from the frame memory 36 via the selection unit 37, to generate a prediction image.

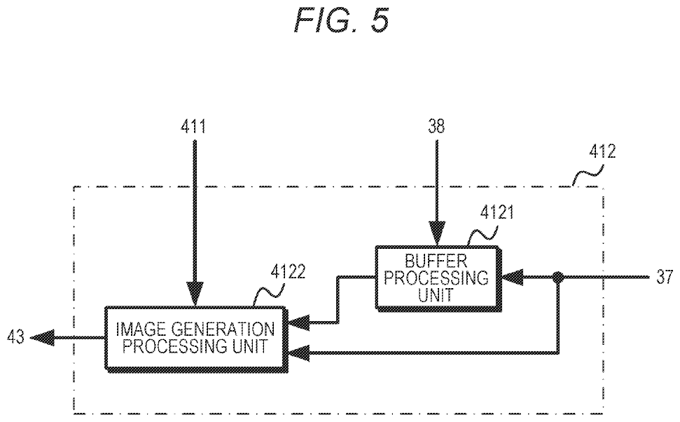

FIG. 5 illustrates a configuration of the prediction image generation unit. The prediction image generation unit 412 has a buffer processing unit 4121 and an image generation processing unit 4122.

The buffer processing unit 4121 holds decoded image data supplied from the frame memory 36 by using line buffers of the maximum number of line buffers calculated by the line buffer number calculation unit 38, and outputs the held decoded image data to the image generation processing unit 4122 as reference image data for intra-prediction.

The image generation processing unit 4122 uses the decoded image data supplied from the frame memory 36 and the reference image data supplied from the buffer processing unit 4121 to generate a prediction image in the optimum prediction mode determined by the intra-mode search unit 411, and outputs the generated prediction image to the prediction selection unit 43 together with the cost function value of the optimum prediction mode.

Returning to FIG. 2, the inter-prediction unit 42 executes inter-prediction processing (motion detection and motion compensation) for each of one or more PUs that are set in each CTU, on the basis of the original image data and the decoded image data. For example, the inter-prediction unit 42 evaluates a cost function value based on a prediction error and a generated code amount, for each of prediction mode candidates included in the search range. Furthermore, the inter-prediction unit 42 selects a prediction mode in which the cost function value is the smallest, that is, a prediction mode in which the compression ratio is the highest, as an optimum inter-prediction mode. Furthermore, the inter-prediction unit 42 generates inter-prediction information including a difference vector having a minimum cost function value, motion information indicating a prediction motion vector, and the like. The inter-prediction unit 42 outputs the prediction image data generated with the optimum inter-prediction mode and the optimum prediction block, the cost function value, and the inter-prediction information, to the prediction selection unit 43.

The prediction selection unit 43 sets the prediction mode for each CTU, CU, or the like on the basis of comparison of cost function values inputted from the intra-prediction unit 41 and the inter-prediction unit 42. For a block for which the intra-prediction mode is set, the prediction selection unit 43 outputs the prediction image data generated by the intra-prediction unit 41 to the arithmetic units 22 and 33, and outputs the intra-prediction information to the reversible coding unit 25. Furthermore, for a block for which the inter-prediction mode is set, the prediction selection unit 43 outputs the prediction image data generated by the inter-prediction unit 42 to the arithmetic units 22 and 33, and outputs the inter-prediction information to the reversible coding unit 25.

<2-2. Operation of Image Coding Apparatus>

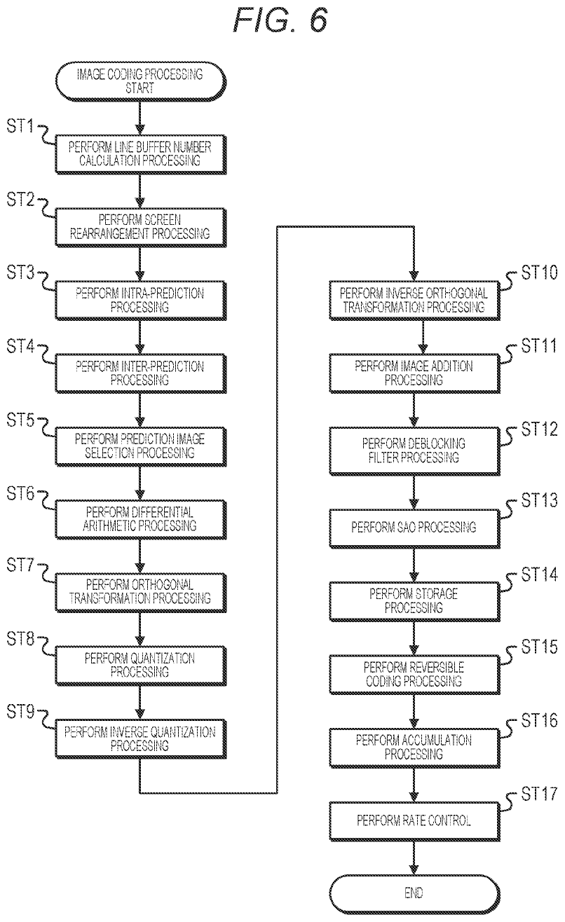

Next, a coding processing operation will be described. FIG. 6 is a flowchart illustrating a coding processing operation of the image coding apparatus.

In step ST1, the image coding apparatus performs line buffer number calculation processing. The line buffer number calculation unit 38 of the image coding apparatus 10 calculates a maximum number of line buffers MaxLumaRefNum to be used for intra-prediction, on the basis of inputted control information or on the basis of control information and information stored in advance.

In step ST2, the image coding apparatus performs screen rearrangement processing. The screen rearrangement buffer 21 of the image coding apparatus 10 rearranges input images in a display order into a coding order, and outputs to the intra-prediction unit 41, the inter-prediction unit 42, and the SAO filter 35.

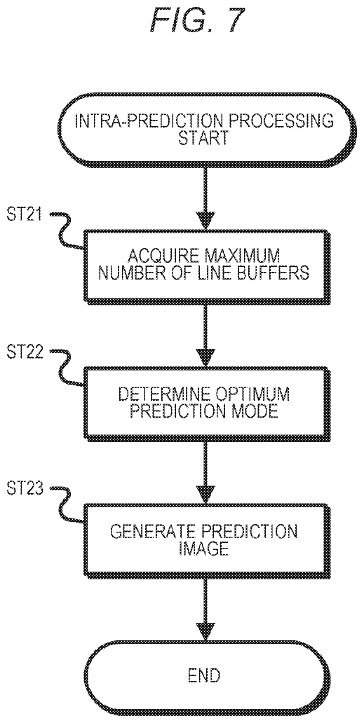

In step ST3, the image coding apparatus performs intra-prediction processing. FIG. 7 is a flowchart illustrating the intra-prediction processing. In step ST21, the intra-prediction unit acquires a maximum number of line buffers. The intra-prediction unit 41 of the image coding apparatus 10 acquires the maximum number of line buffers MaxLumaRefNum calculated by the line buffer number calculation unit 38.

In step ST22, the intra-prediction unit determines an optimum prediction mode. The intra-prediction unit 41 sets a search range of the intra-prediction on the basis of the maximum number of line buffers MaxLumaRefNum acquired in step ST21, uses original image data and reference image data held in line buffers of the maximum number of line buffers to calculate a cost function value for each prediction mode, and determines an optimum prediction mode in which the cost function value is smallest.

In step ST23, the intra-prediction unit generates a prediction image. The intra-prediction unit 41 generates prediction image data by using the optimum prediction mode determined in step ST22 and decoded image data. Moreover, the intra-prediction unit 41 outputs the prediction image data generated in the optimum intra-prediction mode, the cost function value, and the intra-prediction information, to the prediction selection unit 43.

Returning to FIG. 6, in step ST4, the image coding apparatus performs inter-prediction processing. The inter-prediction unit 42 acquires a reference picture in accordance with a current picture, and performs a motion search for all prediction modes to determine which region of the reference picture the current prediction block of the current picture corresponds to. Furthermore, the inter-prediction unit 42 performs optimum inter-prediction mode selection processing and compares cost function values calculated for each prediction mode, to select, for example, a prediction mode in which the cost function value is smallest, as the optimum inter-prediction mode. The inter-prediction unit 42 performs motion compensation in the selected optimum inter-prediction mode, and generates prediction image data. Moreover, the inter-prediction unit 42 outputs the prediction image data generated in the optimum inter-prediction mode, the cost function value, and the inter-prediction information, to the prediction selection unit 43.

In step ST5, the image coding apparatus performs prediction image selection processing. The prediction selection unit 43 of the image coding apparatus 10 determines one of the optimum intra-prediction mode and the optimum inter-prediction mode as the optimum prediction mode, on the basis of cost function values calculated in steps ST3 and ST4. Then, the prediction selection unit 43 selects prediction image data of the determined optimum prediction mode, and outputs to the arithmetic units 22 and 33. Note that the prediction image data is used for arithmetic operation of steps ST6 and ST11 described later. Furthermore, the prediction selection unit 43 outputs the intra-prediction information or the inter-prediction information of the optimum prediction mode to the reversible coding unit 25.

In step ST6, the image coding apparatus performs differential arithmetic processing. The arithmetic unit 22 of the image coding apparatus 10 calculates a difference between the original image data rearranged in step ST2 and the prediction image data selected in step ST5, and outputs residual data, which is a difference result, to the orthogonal transformation unit 23.

In step ST7, the image coding apparatus performs orthogonal transformation processing. The orthogonal transformation unit 23 of the image coding apparatus 10 orthogonally transforms the residual data supplied from the arithmetic unit 22. Specifically, orthogonal transformation such as discrete cosine transformation is performed, and an obtained transform coefficient is outputted to the quantization unit 24.

In step ST8, the image coding apparatus performs quantization processing. The quantization unit 24 of the image coding apparatus 10 quantizes the transform coefficient supplied from the orthogonal transformation unit 23. In this quantization, a rate is controlled as described in the process of step ST17 described later.

Quantization information generated as described above is locally decoded as follows. That is, in step ST9, the image coding apparatus performs inverse quantization processing. The inverse quantization unit 31 of the image coding apparatus 10 inversely quantizes quantization data outputted from the quantization unit 24 with characteristics corresponding to the quantization unit 24.

In step ST10, the image coding apparatus performs inverse orthogonal transformation processing. The inverse orthogonal transformation unit 32 of the image coding apparatus 10 performs inverse orthogonal transformation on inverse quantization data generated by the inverse quantization unit 31 with characteristics corresponding to the orthogonal transformation unit 23 to generate residual data, and outputs to the arithmetic unit 33.

In step ST11, the image coding apparatus performs image addition processing. The arithmetic unit 33 of the image coding apparatus 10 adds prediction image data outputted from the prediction selection unit 43 to locally decoded residual data, to generate an image that is locally decoded (that is, subjected to local decoding).

In step ST12, the image coding apparatus performs deblocking filter processing. The deblocking filter 34 of the image coding apparatus 10 performs the deblocking filter processing on image data outputted from the arithmetic unit 33, removes block distortion, and outputs to the SAO filter 35 and the frame memory 36.

In step ST13, the image coding apparatus performs SAO processing. The SAO filter 35 of the image coding apparatus 10 performs the SAO processing on image data outputted from the deblocking filter 34. By this SAO processing, a type and a coefficient of the SAO processing are obtained for each LCU, which is a maximum unit of coding, and filtering processing is performed using them. The SAO filter 35 causes the image data after the SAO processing to be stored in the frame memory 36. Furthermore, the SAO filter 35 outputs parameters related to the SAO processing to the reversible coding unit 25, and codes them in step ST15 as described later.

In step ST14, the image coding apparatus performs storage processing. The frame memory 36 of the image coding apparatus 10 stores an image before the filter processing by the deblocking filter 34 or the like and an image after the filter processing by the deblocking filter 34 or the like.

Whereas, the transform coefficient quantized in step ST8 described above is also outputted to the reversible coding unit 25. In step ST15, the image coding apparatus performs reversible coding processing. The reversible coding unit 25 of the image coding apparatus 10 generates a coded stream by coding the transform coefficient after quantization outputted from the quantization unit 24 and the supplied intra-prediction information, inter-prediction information, and the like. Furthermore, control information is included in the coded stream.

In step ST16, the image coding apparatus performs accumulation processing. The accumulation buffer 26 of the image coding apparatus 10 accumulates coded data. The coded data accumulated in the accumulation buffer 26 is appropriately read out and transmitted to the decoding side via a transmission line or the like.

In step ST17, the image coding apparatus performs rate control. The rate control unit 27 of the image coding apparatus 10 controls a rate of the quantization operation of the quantization unit 24 such that the coded data accumulated in the accumulation buffer 26 do not overflow or underflow.

<2-2-1. First Operation of Line Buffer Number Calculation Unit>

The line buffer number calculation unit 38 calculates a number of line buffers on the basis of level information and input image information. The level information indicates a level selected from a plurality of preset levels. For example, the level is selected on the basis of a configuration of a memory or the like of the image coding apparatus, a memory configuration of an image decoding apparatus that decodes a coded stream generated by the image coding apparatus, and the like. In the input image information, a horizontal size (pic_width) and a vertical size (pic_height) of an input image are shown. The line buffer number calculation unit 38 outputs the maximum number of line buffers (MaxLumaRefNum) calculated on the basis of the level information and the input image information, to the intra-prediction unit 41.

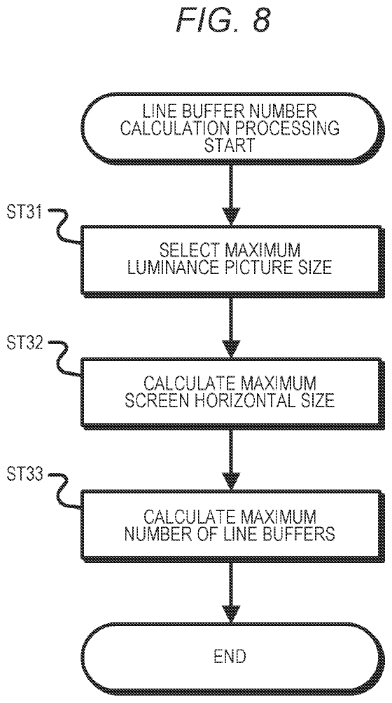

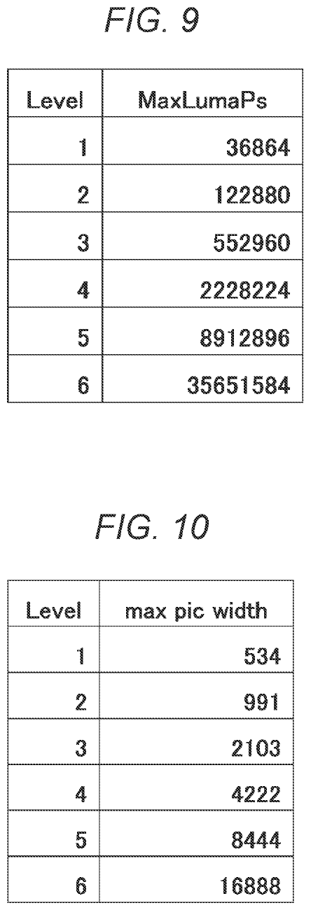

FIG. 8 is a flowchart showing a first operation of the line buffer number calculation unit. In step ST31, the line buffer number calculation unit selects a maximum luminance picture size. FIG. 9 shows a relationship between a level (Level) and a maximum luminance picture size (MaxLumaPs). The image processing apparatus corresponding to each level has ability to code an image containing “MaxLumaPs” pieces of pixel in a screen. The line buffer number calculation unit 38 selects the maximum luminance picture size (MaxLumaPs) corresponding to the level indicated by the level information.

In step ST32, the line buffer number calculation unit calculates a maximum screen horizontal size. The maximum screen horizontal size (max_pic_width) can be calculated using the maximum luminance picture size (MaxLumaPs) as shown in Equation (1).

max_pict_width=Sqrt(MaxLumaPs×8) (1)

The line buffer number calculation unit 38 performs arithmetic operation of Equation (1) by using the maximum luminance picture size (MaxLumaPs) selected in step ST31, and calculates the maximum screen horizontal size (max_pic_width).

In step ST33, the line buffer number calculation unit calculates the maximum number of line buffers. The maximum number of line buffers (MaxLumaRefNum) can be calculated using the maximum luminance picture size (MaxLumaPs) and the horizontal size (pic_width) of the input image as shown in Equation (2). Note that, in Equation (2), floor ( ) is a function that returns the largest integer equal to or less than the number in parentheses.

MaxLumaRefNum=floor(max_pic_width/pic_width) (2)

The line buffer number calculation unit 38 performs arithmetic operation of Equation (2) using the maximum luminance picture size (MaxLumaPs) selected in step ST31 and the maximum screen horizontal size (max_pic_width) calculated in step ST32, to calculate the maximum number of line buffers (MaxLumaRefNum).

FIG. 10 shows a relationship between a level and a maximum screen horizontal size (max_pic_width). For example, the image coding apparatus 10 that supports level “6” has a line buffer that stores pixel data of “8444”, which is the maximum screen horizontal size (max_pic_width).

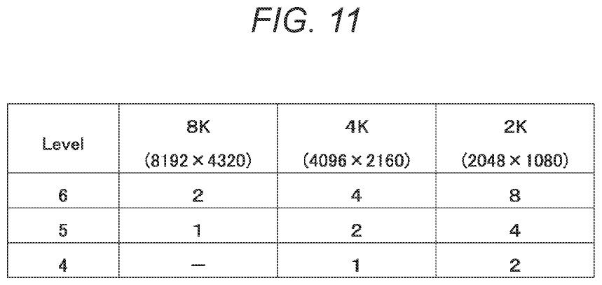

Therefore, as shown in FIG. 11, the number of intra-prediction line buffers that can be used in a case where the input image is an 8K image is to be two lines. In a case of the image processing apparatus that supports level 6, the number of intra-prediction line buffers that can be used in a case where the input image is a 4K image is to be four lines, and the number of intra-prediction line buffers that can be used in a case where the input image is a 2K image is to be eight lines. Furthermore, in a case of the image processing apparatus that supports level 5, the number of intra-prediction line buffers that can be used in a case where the input image is an 8K image is to be one line, the number of intra-prediction line buffers that can be used in a case where the input image is an 4K image is to be two lines, and the number of intra-prediction line buffers that can be used in a case where the input image is an 2K image is to be four lines.

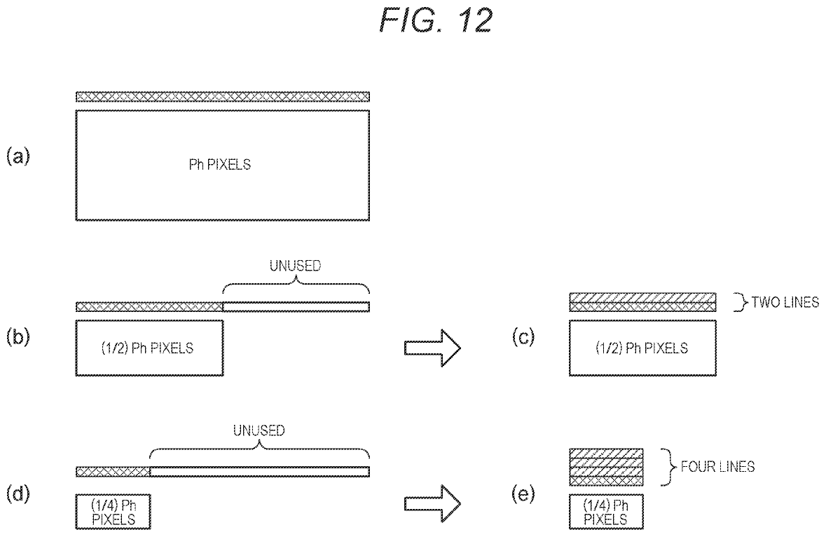

FIG. 12 illustrates a line buffer that can be used for intra-prediction. For example, as shown in (a) of FIG. 12, in a case where a number of horizontal pixels of the input image is Phy pixels and a line buffer of one line can be used, in a case where the number of horizontal pixels of the input image is (½) Ph pixels, an unused buffer cannot be used as shown in (b) of FIG. 12 unless the maximum number of line buffers is calculated and a line buffer is provided as in the present technology. However, if the maximum number of line buffers is calculated and the line buffer is set as in the present technology, a line buffer of two lines can be used as shown in (c) of FIG. 12. Furthermore, in a case where the number of horizontal pixels in the input image is (¼) Ph pixels, the number of unused buffers will be larger than that in the case of (½) Ph pixels as shown in (d) of FIG. 12, unless the maximum number of line buffers is calculated and a line buffer is provided as in the present technology. However, if the maximum number of line buffers is calculated and the line buffer is set as in the present technology, a line buffer of four lines can be used as shown in (e) of FIG. 12.

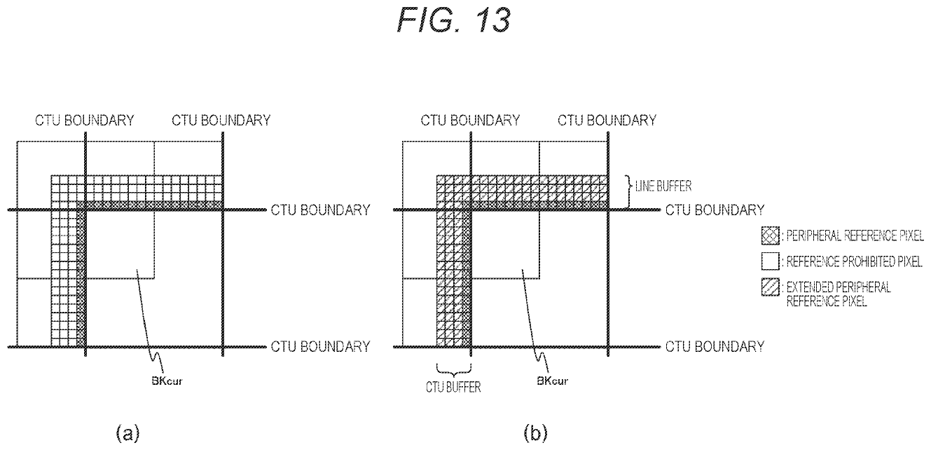

FIG. 13 illustrates a reference pixel line in intra-prediction. FIG. 13(a) illustrates a reference pixel line in a case where the present technology is not used, and FIG. 13(b) illustrates a reference pixel line in a case where the present technology is desired to be used. In a case where the present technology is not used, in a case where an upper side of a current block BKcur to be processed is a CTU boundary, pixels of one line adjacent to the upper side are used as reference pixels (peripheral reference pixels). On the other hand, according to the present technology, it is possible to use pixels of four lines adjacent to the upper side as reference pixels (peripheral reference pixels+extended peripheral reference pixels). Note that, in a case where a left side of the current block BKcur is the CTU boundary, a pixel of a CTU buffer that stores a pixel of a block adjacent to the left side is used as the reference pixel.

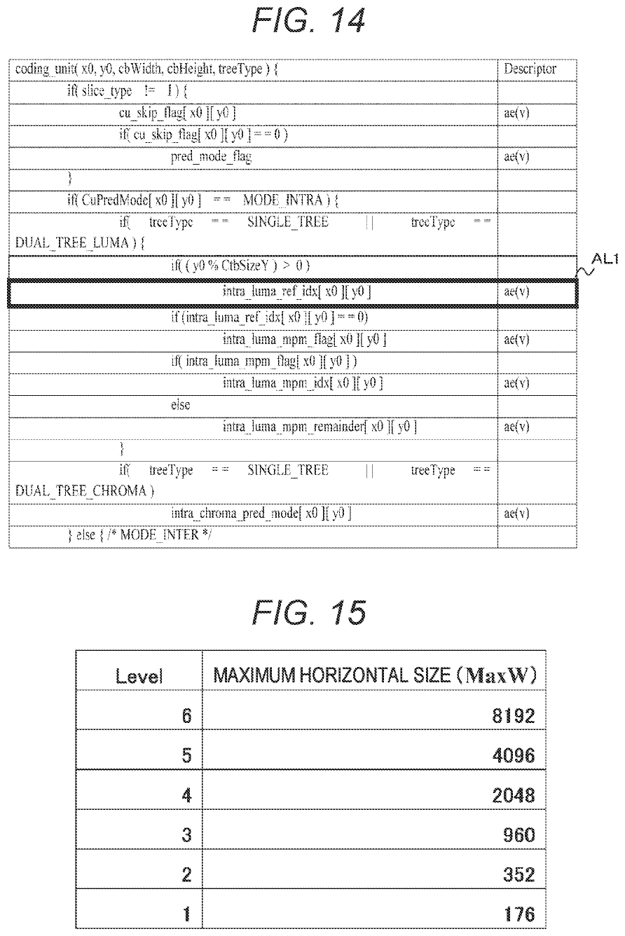

FIG. 14 illustrates syntax of a coding unit. Note that, although not shown, a level identifier syntax “general_level_idc” indicating a level is provided at a position higher than the coding unit.

In the syntax of the coding unit, a reference pixel line index (intra_luma_ref_idx [x0] [y0]) indicated by a frame line AL1 is set on the basis of the maximum number of line buffers (MaxLumaRefNum) calculated by the line buffer number calculation unit 38.

According to such the present technology, resources of the line buffer can be effectively used when the input image has a size other than a maximum image frame. Therefore, the coding efficiency can be improved as compared with a case where the lines used at the CTU boundary are uniformly restricted to one line.

<2-2-2. Second Operation of Line Buffer Number Calculation Unit>

In the first operation of the line buffer number calculation unit described above, the maximum number of line buffers (MaxLumaRefNum) is calculated on the basis of: the maximum screen horizontal size (max_pic_width) calculated on the basis of the maximum luminance picture size (MaxLumaPs) corresponding to the level (Level); and on the basis of the horizontal size (pic_width) of the input image, but information stored in the image processing apparatus may be used for calculating the maximum number of line buffers.

In the second operation, for example, a relationship between a level (Level) and a maximum horizontal size (MaxW) shown in FIG. 15 is stored in advance, and the maximum horizontal size (MaxW) is used as the maximum screen horizontal size (max_pic_width).

The line buffer number calculation unit 8 performs arithmetic operation of Equation (2) by using the maximum screen horizontal size (max_pic_width=MaxW) corresponding to a level (Level) indicated by the level information and the horizontal size (pic_width) of the input image, to calculate the maximum number of line buffers (MaxLumaRefNum).

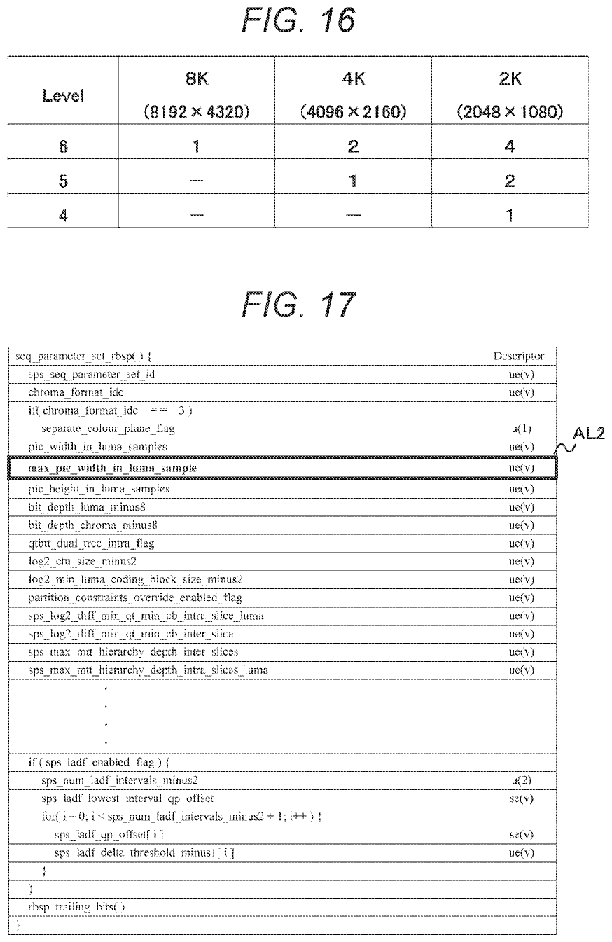

Therefore, as shown in FIG. 16, the number of intra-prediction line buffers that can be used in a case where the input image is an 8K image is to be one line. In a case of the image processing apparatus that supports level 6, the number of intra-prediction line buffers that can be used in a case where the input image is an 4K image is to be two lines, and the number of intra-prediction line buffers that can be used in a case where the input image is an 2K image is to be four lines. Furthermore, in a case of an image processing apparatus that supports level 5, it is not possible to process 8K images, the number of intra-prediction line buffers that can be used in a case where the input image is an 4K image is to be one line, and the number of intra-prediction line buffers that can be used in a case where the input image is an 2K image is to be two lines.

FIG. 17 illustrates a part of syntax of a sequence parameter set. To the sequence parameter set, as shown by a frame line AL2, syntax “max_pic_width_in_luma_sample” indicating the maximum screen horizontal size (max_pic_width) stored in advance is set.

In this way, the line buffer number calculation unit 38 is to be able to calculate the maximum number of line buffers (MaxLumaRefNum) more easily than the first operation, by storing the maximum horizontal size (=maximum screen horizontal size) in advance.

<2-2-3. Other Operations of Intra-Prediction Unit>

In intra-prediction, a cross-component liner model (CCML) prediction that generates a prediction value of a color difference signal by using a decoded pixel value of a luminance signal has been proposed. In other operations of the intra-prediction unit, the line buffer is made to be effectively used in CCML prediction shown in the patent document “Japanese Patent Application Laid-Open No. 2013-110502” and the above-mentioned Non Patent Document 1 “B. Bross, J. Chen, S. Liu, “Versatile Video Coding (Draft 3),” document JVET-L1001, 12th JVET meeting: Macao, CN, 3-12, Oct. 2018”.

In a linear model (LM) mode included in candidates for a prediction mode for a color difference component, a prediction pixel value pred_{c} (x, y) is calculated using, for example, a prediction function shown in Equation (3). Note that, in Equation (3), rec_{L}′ (x, y) indicates a value after downsampling of a luminance component of a decoded image, and “α” and “β” are coefficients. Downsampling of the luminance component is performed in a case where a density of a color difference component differs from a density of a luminance component, depending on a chroma format.

pred_{c}(x,y)=α×rec_{L}′(x,y)+β (3)

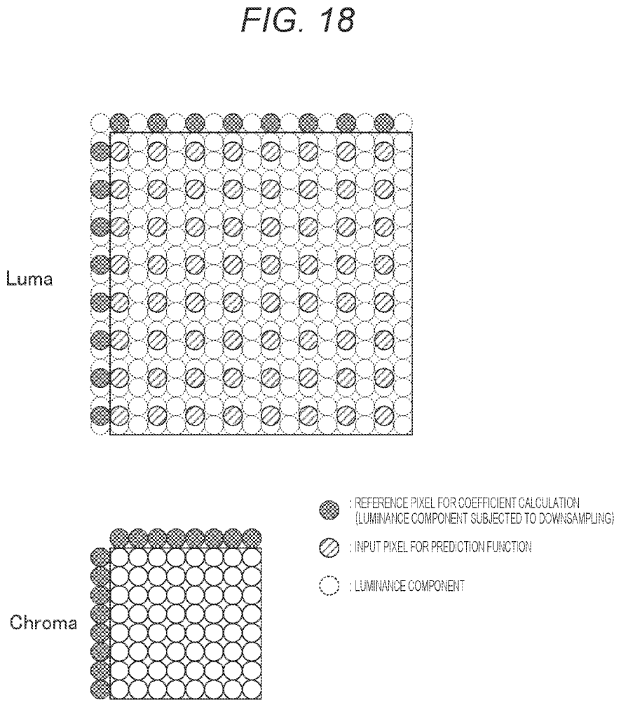

FIG. 18 conceptually shows, with circles, a luminance component (Luma) and a corresponding color difference component (Chroma) in one PU having a size of 16-16 pixels in a case where the chroma format is 4:2:0. A density of the luminance component is twice a density of the color difference component in each of a horizontal direction and a vertical direction. Filled circles located around the PU in the figure indicate reference pixels that are referred to when the coefficients α and β of a prediction function are calculated. Shaded circles are luminance components subjected to downsampling, and are input pixels of the prediction function. By substituting a value of the luminance component subjected to downsampling in this way as rec_{L}′(x, y) of the prediction function shown in Equation (3), a prediction value of a color difference component at a common pixel position is calculated. Furthermore, the reference pixel is also subjected to downsampling in a similar manner.

In a case where the chroma format is 4:2:0, as shown in FIG. 18, an input value (a value substituted in the prediction function) of one luminance component is generated for every 2×2 luminance components by downsampling. The downsampling is performed by filtering, with a two-dimensional filter, a value of a filter tap including one or more luminance components at pixel positions that are common to individual color difference components and one or more luminance components at pixel positions that are not common to this color difference component. Here, the luminance component at a pixel position that is “common” to a certain color difference component includes pixel positions (2x, 2y), (2x+1, 2y), (2x, 2y+1) and (2x+1, 2y+1) of a luminance component with respect to a pixel position (x, y) of a color difference component, in a case where the chroma format is 4:2:0.

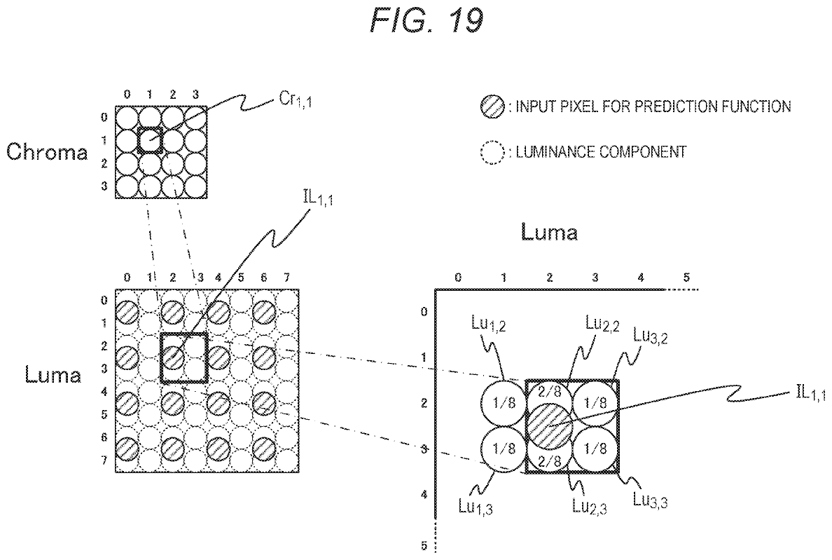

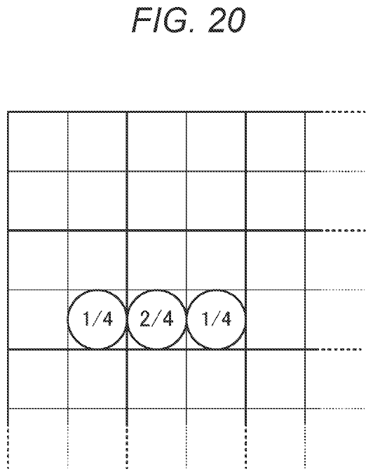

FIG. 19 is a view illustrating a downsampling method. In the upper left of FIG. 19, a color difference component Cr_{1,1} at a pixel position (1, 1) is shown. A prediction value of the color difference component Cr_{1,1} is calculated by substituting an input value IL_{1,1} of the luminance component into the prediction function. The input value IL_{1,1} of the luminance component can be generated by filtering a value of a 3×2 filter tap including luminance components Lu_{2,2}, Lu_{3,2}, Lu_{2,3}, and Lu_{3,3} at pixel positions common to the color difference component Cr_{1,1}, and luminance components Lu_{1,2}, and Lu_{1,3} at pixel positions that are not common to the color difference component Cr_{1,1}. Numbers shown in circles of the filter taps in the figure are filter coefficients to be multiplied by each filter tap. In this way, by also including luminance components around a pixel position that is common to each color difference component into the filter tap during downsampling, effects of noise in the luminance component is reduced, and accuracy of intra-prediction in the LM mode is improved.

In a case where such downsampling on a luminance component is performed by the intra-prediction unit, the intra-prediction unit performs the downsampling processing at the CTU boundary with a number of filter taps according to the number of line buffers calculated by the line buffer number calculation unit 38.

Specifically, when the maximum number of line buffers (MaxLumaRefNum) is 2 or more, as shown in FIG. 19, six taps (three taps in the horizontal direction x two taps in a vertical direction) are filtered to calculate a prediction value, which is a luminance component at a pixel position common to the color difference component. Furthermore, when the maximum number of line buffers (MaxLumaRefNum) is 1 or less, filtering of three taps in a horizontal direction is performed as shown in FIG. 20 to calculate a prediction value, which is a luminance component at a pixel position common to the color difference component.

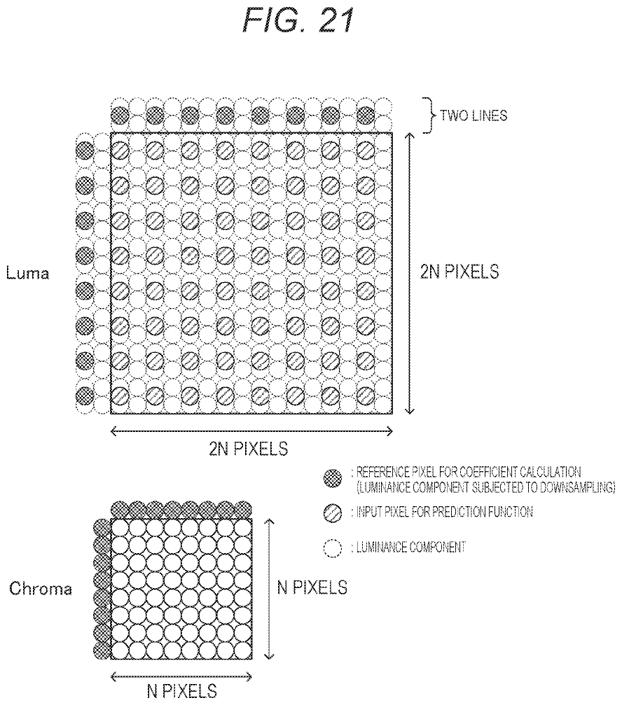

By performing such processing, as shown in FIG. 21, the color difference component can be calculated by using the prediction value of a luminance component of the reference pixel obtained by filtering using luminance components of two lines when the maximum number of line buffers (MaxLumaRefNum) is 2 or more. Furthermore, when the maximum number of line buffers (MaxLumaRefNum) is 1 or less, the color difference component can be calculated by using the prediction value of the luminance component obtained by filtering using the luminance components of one line.

<2-2-4. Deblocking Filter Processing Operation>

A description has been given to a case where the image coding apparatus performs intra-prediction by using the number of line buffers calculated by the line buffer number calculation unit 38, but the filter processing of the deblocking filter 34 may be switched on the basis of the number of line buffers calculated by the line buffer number calculation unit 38.

Here, in a case where the number of lines required for the deblocking filter corresponding to the maximum screen horizontal size is N lines, the line buffer number calculation unit 38 calculates the maximum number of line buffers MaxLineBufNum for the deblocking filter 34 on the basis of Equation (4).

MaxLineBufNum=floor(N×max_pic_width/pic_width) (4)

The deblocking filter 34 switches the number of taps in the vertical direction in accordance with the maximum number of line buffers MaxLineBufNum. For example, in a case where the number of line buffers is “1” or less, the number of taps in the vertical direction is set to “N”. Furthermore, in a case where the number of line buffers is “2” or more, the number of taps in the vertical direction is set larger than “N”.

By adjusting the number of filter taps in accordance with the number of line buffers in this way, it becomes possible to effectively utilize the line buffer provided in the deblocking filter 34 to perform the deblocking filter processing.

<2-2-5. Operation at Tile Division>

In the image coding processing, tile division is possible since pictures are decoded in parallel, and a unit of the tile division is a unit of the CTU. Therefore, the line buffer number calculation unit 38 calculates the number of line buffers for each tile by using a tile horizontal size (tile_column_width) in a case where tile division is performed. Equation (5) calculates the maximum number of line buffers (MaxLineBufNum) for each tile.

MaxLumaRefNum=floor(max_pic_width/tile_column_width) (5)

In this way, by the line buffer number calculation unit 38 calculating the maximum number of line buffers (MaxLineBufNum) for each tile, the intra-prediction unit 41 can effectively use the line buffer to improve the prediction accuracy even in a case of performing intra-prediction for each tile.

### 3. About Image Decoding Processing

Next, decoding processing of a coded stream generated by the image coding apparatus will be described.

<3-1. Configuration of Image Decoding Apparatus>

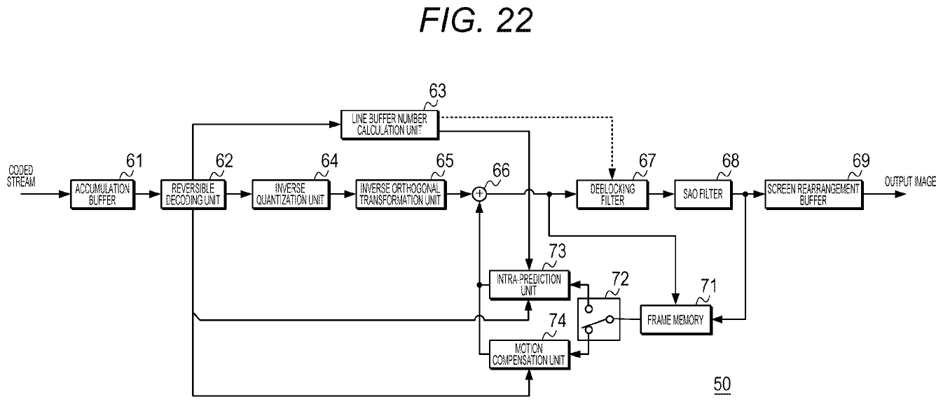

FIG. 22 illustrates a configuration of an image decoding apparatus configured to perform decoding processing on a coded stream, and an image decoding apparatus 50 is an image decoding apparatus corresponding to the image coding apparatus 10 shown in FIG. 2. A coded stream generated by the image coding apparatus 10 is supplied to the image decoding apparatus 50 and decoded.

The image decoding apparatus 50 has an accumulation buffer 61, a reversible decoding unit 62, a line buffer number calculation unit 63, an inverse quantization unit 64, an inverse orthogonal transformation unit 65, an arithmetic unit 66, a deblocking filter 67, a SAO filter 68, and a screen rearrangement buffer 69. Furthermore, the image decoding apparatus 50 includes a frame memory 71, a selection unit 72, an intra-prediction unit 73, and a motion compensation unit 74.

The accumulation buffer 61 receives and accumulates a transmitted coded stream. This coded stream is read out and outputted to the reversible decoding unit 62, at a predetermined timing.

Furthermore, the reversible decoding unit 62 has a function of parsing. The reversible decoding unit 62 outputs information included in a decoding result of the coded stream, for example, level information and input image information, to the line buffer number calculation unit 63. Furthermore, the reversible decoding unit 62 parses intra-prediction information, inter-prediction information, filter control information, and the like, and supplies to a necessary block.

The line buffer number calculation unit 63 performs processing similar to that of the line buffer number calculation unit 38 of the image coding apparatus 10, calculates the maximum number of line buffers (MaxLumaRefNum) on the basis of the level (Level) indicated by the level information and the input image size information (pic_width, pic_height) indicated by the input image information, and outputs to the intra-prediction unit 73. Furthermore, in a case where the filter processing of the deblocking filter 34 is switched on the basis of the number of line buffers in the image coding apparatus 10, the line buffer number calculation unit 63 calculates the maximum number of line buffers (MaxLineBufNum) and outputs to the deblocking filter 67.

The inverse quantization unit 64 inversely quantizes quantization data obtained by decoding with the reversible decoding unit 62 by a method corresponding to the quantization method of the quantization unit 24 in FIG. 2. The inverse quantization unit 64 outputs the inversely quantized data to the inverse orthogonal transformation unit 65.

The inverse orthogonal transformation unit 65 performs inverse orthogonal transformation by a method corresponding to the orthogonal transformation method of the orthogonal transformation unit 23 in FIG. 2, to obtain decoding residual data corresponding to residual data before the orthogonal transformation in the image coding apparatus 10, and outputs to the arithmetic unit 66.

To the arithmetic unit 66, prediction image data is supplied from the intra-prediction unit 73 or the motion compensation unit 74. The arithmetic unit 66 adds the decoding residual data and the prediction image data, to obtain decoded image data corresponding to original image data before the prediction image data is subtracted by the arithmetic unit 22 of the image coding apparatus 10. The arithmetic unit 66 outputs the decoded image data to the deblocking filter 67.

The deblocking filter 67 removes block distortion of the decoded image by performing deblocking filter processing similar to that of the deblocking filter 34 of the image coding apparatus 10. The deblocking filter 67 outputs image data after the filter processing to the SAO filter 68. Furthermore, the deblocking filter 67 switches the filter processing on the basis of the calculated number of line buffers, similarly to the deblocking filter 34 of the image coding apparatus 10.

The SAO filter 68 performs SAO processing on the image data filtered by the deblocking filter 67. The SAO filter 68 performs filter processing on the image data filtered by the deblocking filter 67 for each LCU by using parameters supplied from the reversible decoding unit 62, and outputs to the screen rearrangement buffer 69.

The screen rearrangement buffer 69 rearranges images. That is, an order of frames rearranged for a coding order by the screen rearrangement buffer 21 of FIG. 2 is rearranged into the original display order.

The output of the SAO filter 68 is further supplied to the frame memory 71. The selection unit 72 reads out image data to be used for intra-prediction from the frame memory 71, and outputs to the intra-prediction unit 73. Furthermore, the selection unit 72 reads out, from the frame memory 71, image data to be used for inter-prediction and image data to be referred to, and outputs to the motion compensation unit 74.

The intra-prediction unit 73 is configured by excluding the intra-mode search unit 411 from the configuration of the intra-prediction unit shown in FIG. 3 of the image coding apparatus 10. The intra-prediction unit 73 uses, as reference image data, decoded image data for a line, which is the maximum number of line buffers (MaxLumaRefNum) calculated by the line buffer number calculation unit 63, to generate prediction image data in an optimum intra-prediction mode indicated by the intra-prediction information supplied from the reversible decoding unit 62, and outputs the generated prediction image data to the arithmetic unit 66. Furthermore, in a case where CCML prediction is performed by the intra-prediction unit 73, similarly to the intra-prediction unit 41 of the image coding apparatus 10, the filtering processing is switched in accordance with the maximum number of line buffers (MaxLumaRefNum).

The motion compensation unit 74 generates prediction image data from the image data acquired from the frame memory 71 on the basis of inter-prediction information outputted by parsing information contained in a decoding result of a coded bitstream of the reversible decoding unit 62, and outputs to the arithmetic unit 66.

### <3-2. Operation of Image Decoding Apparatus>

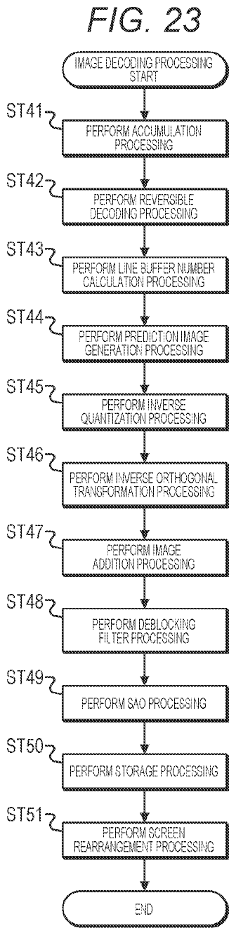

Next, an operation of an embodiment of the image decoding apparatus will be described. FIG. 23 is a flowchart illustrating an operation of the image decoding apparatus.

In step ST41, the image decoding apparatus performs accumulation processing. The accumulation buffer 61 of the image decoding apparatus 50 receives and accumulates a coded stream.

In step ST42, the image decoding apparatus performs reversible decoding processing. The reversible decoding unit 62 of the image decoding apparatus 50 decodes a coded stream supplied from the accumulation buffer 61. The reversible decoding unit 62 parses information contained in a decoding result of the coded stream, and supplies to a necessary block. The reversible decoding unit 62 outputs level information and input image information to the line buffer number calculation unit 63. Furthermore, the reversible decoding unit 62 outputs intra-prediction information to the intra-prediction unit 73, and outputs inter-prediction information to the motion compensation unit 74.

In step ST43, the image decoding apparatus performs line buffer number calculation processing. The line buffer number calculation unit 63 of the image decoding apparatus 50 calculates the maximum number of line buffers (MaxLumaRefNum) on the basis of a level (Level) indicated by the level information and input image size information (pic_width, pic_height) indicated by the input image information, and outputs to the intra-prediction unit 73. Furthermore, in a case where the filter processing of the deblocking filter 34 is switched on the basis of the maximum number of line buffers (MaxLineBufNum) in the image coding apparatus 10, the line buffer number calculation unit 63 calculates the maximum number of line buffers (MaxLineBufNum) and outputs to the deblocking filter 67.

In step ST44, the image decoding apparatus performs prediction image generation processing. The intra-prediction unit 73 or the motion compensation unit 74 of the image decoding apparatus 50 individually performs prediction image generation processing for the intra-prediction information and the inter-prediction information supplied from the reversible decoding unit 62. That is, in a case where the intra-prediction information is supplied from the reversible decoding unit 62, the intra-prediction unit 73 generates prediction image data in an optimum intra-prediction mode indicated by the intra-prediction information. Furthermore, the intra-prediction unit 73 uses line buffers of the maximum number of line buffers (MaxLumaRefNum) calculated by the line buffer number calculation unit 63, to perform intra-prediction using reference pixels stored in the line buffer.

In step ST45, the image decoding apparatus performs inverse quantization processing. The inverse quantization unit 64 of the image decoding apparatus 50 inversely quantizes quantization data obtained by the reversible decoding unit 62 by a method corresponding to the quantization method of the quantization unit 24 of FIG. 2, and outputs the inverse quantization data to the inverse orthogonal transformation unit 65.

In step ST46, the image decoding apparatus performs inverse orthogonal transformation processing. The inverse orthogonal transformation unit 65 of the image decoding apparatus 50 performs inverse orthogonal transformation by a method corresponding to the orthogonal transformation method of the orthogonal transformation unit 23 in FIG. 2, to obtain decoding residual data corresponding to residual data before the orthogonal transformation in the image coding apparatus 10, and outputs to the arithmetic unit 66.

In step ST47, the image decoding apparatus performs image addition processing. The arithmetic unit 66 of the image decoding apparatus 50 adds the prediction image data generated by the intra-prediction unit 73 or the motion compensation unit 74 in step ST44 to the decoding residual data supplied from the inverse orthogonal transformation unit 65, to generate decoded image data. The arithmetic unit 66 outputs the generated decoded image data to the deblocking filter 67 and the frame memory 71.

In step ST48, the image decoding apparatus performs deblocking filter processing. The deblocking filter 67 of the image decoding apparatus 50 performs deblocking filter processing on an image outputted from the arithmetic unit 66. As a result, block distortion is removed. Furthermore, in the deblocking filter processing, the filter processing is switched on the basis of the maximum number of line buffers (MaxLineBufNum) calculated in step ST43. The decoded image subjected to the filter processing by the deblocking filter 67 is outputted to the SAO filter 68.

In step ST49, the image decoding apparatus performs SAO processing. The SAO filter 68 of the image decoding apparatus 50 performs the SAO processing on the image filtered by the deblocking filter 67, by using parameters related to the SAO processing supplied from the reversible decoding unit 62. The SAO filter 68 outputs the decoded image data after the SAO processing to the screen rearrangement buffer 69 and the frame memory 71.

In step ST50, the image decoding apparatus performs storage processing. The frame memory 71 of the image decoding apparatus 50 stores decoded image data before the filter processing supplied from the arithmetic unit 66 and decoded image data subjected to the filter processing by the deblocking filter 67 and the SAO filter 68.

In step ST51, the image decoding apparatus performs screen rearrangement processing. The screen rearrangement buffer 69 of the image decoding apparatus 50 accumulates decoded image data supplied from the SAO filter 68, and outputs the accumulated decoded image data in a display order before being rearranged by the screen rearrangement buffer 21 of the image coding apparatus 10.

By performing such decoding processing, it is possible to decode the coded stream generated by the image coding apparatus 10 described above.

### 4. Other Operations of Image Processing Apparatus

Meanwhile, in the coding processing and the decoding processing, it may be possible to switch from conventional image processing using only one line buffer, without limiting to image processing using a buffer of multiple lines as in the present technology. By providing information indicating whether or not multiple lines can be used, for example, a flag enable_mlr_ctu_boundary, and referring to this flag, it makes it possible to determine whether or not the process allows use of multiple lines.

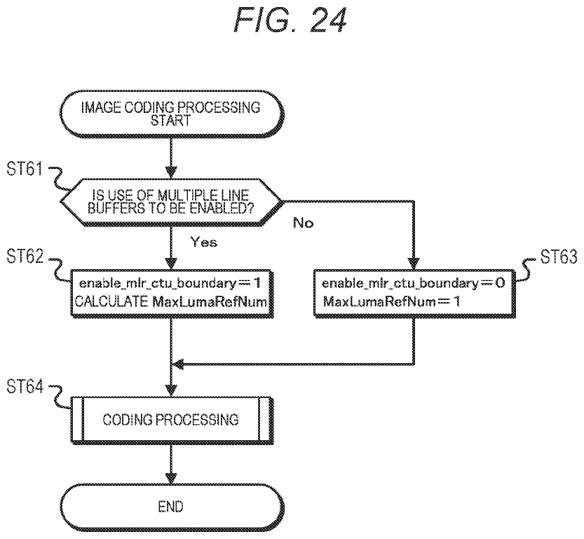

FIG. 24 is a flowchart showing an operation of the image coding apparatus. In step ST61, the image coding apparatus 10 determines whether to enable use of a multiple-line buffer. The image coding apparatus 10 proceeds to step ST62 in a case where the control information indicates, for example, that reference image data for multiple lines can be used at the CTU boundary in intra-prediction, and proceeds to step ST63 in a case where reference image data for multiple lines is not used at the CTU boundary, that is, in a case where only reference image data for one line is used at the CTU boundary.

In step ST62, the image coding apparatus 10 sets a flag (enable_mlr_ctu_boundary) to “1”. Furthermore, as described above, the maximum number of line buffers (MaxLumaRefNum) is calculated and the process proceeds to step ST64.

In step ST63, the image coding apparatus 10 sets the flag (enable_mlr_ctu_boundary) to “0”. Furthermore, the maximum number of line buffers (MaxLumaRefNum) is set to “1” and the process proceeds to step ST64.

In step ST64, the image coding apparatus 10 performs coding processing. The image coding apparatus 10 uses, as a calculation result of the line buffer number calculation unit 38, the maximum number of line buffers (MaxLumaRefNum) set in step ST62 or step ST63 to perform the coding processing, that is, perform the processes of steps ST2 to ST17 of FIG. 6 to generate a coded stream.

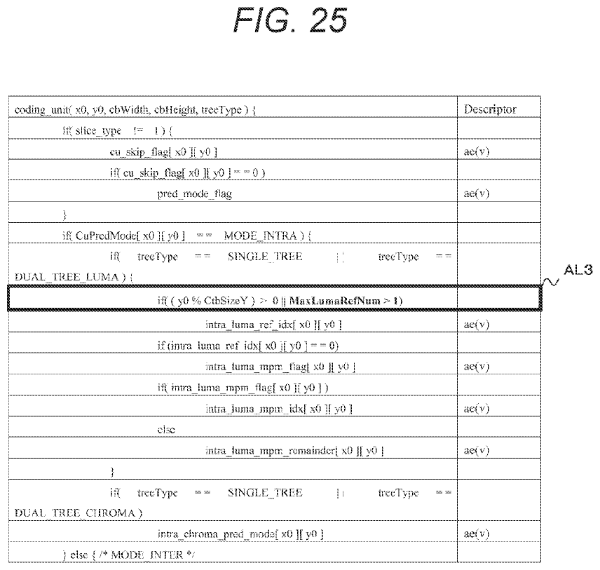

FIG. 25 illustrates syntax of a coding unit. In this syntax, as shown by a frame line AL3, in a case where the maximum number of line buffers (MaxLumaRefNum) is greater than “1” at the CTU boundary, a luminance reference pixel line index (intra_luma_ref_idx [x0] [y0]) is shown, and a luminance reference pixel line (IntraLumaRefLineIdx [x0] [y0]) can be determined, as shown in FIG. 1.

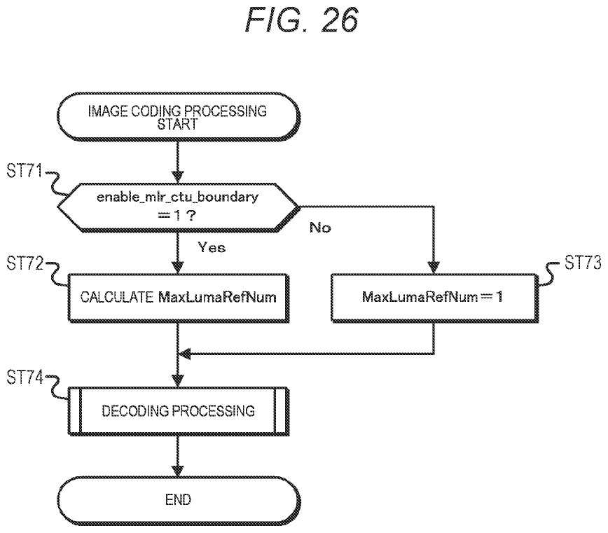

FIG. 26 is a flowchart showing an operation of the image decoding apparatus. In step ST71, the image decoding apparatus 50 determines whether the flag (enable_mlr_ctu_boundary) is “1”. The image decoding apparatus 50 proceeds to step ST72 in a case where the flag (enable_mlr_ctu_boundary) is “1”, and proceeds to step ST73 in a case where the flag (enable_mlr_ctu_boundary) is not “1”.

In step ST72, the image decoding apparatus 50 calculates the maximum number of line buffers (MaxLumaRefNum) and proceeds to step ST74.

In step ST73, the image decoding apparatus 50 proceeds to step ST74 with the maximum number of line buffers (MaxLumaRefNum) set to “1”.

In step ST74, the image decoding apparatus 50 performs decoding processing. The image decoding apparatus 50 uses, as a calculation result of the line buffer number calculation unit 63, the maximum number of line buffers (MaxLumaRefNum) set in step ST72 or step ST73 to perform the decoding processing as described above, that is, the processes of steps ST42 to ST51 of FIG. 23, and outputs image data before the coding processing.

By providing the flag (enable_mlr_ctu_boundary) in this way, either codec processing using a buffer of multiple lines or codec processing using only one line buffer can be selectively used.

### 5. Application Example

Next, an application example of the image processing apparatus of the present technology will be described. The image processing apparatus of the present technology can be applied to an imaging device that captures a moving image. In this case, by providing the image coding apparatus 10 in the imaging device, a coded stream having high coding efficiency can be recorded on a recording medium or outputted to an external device. Furthermore, by providing the image decoding apparatus 50 in the imaging device, a coded stream can be decoded and an image can be recorded and reproduced. Furthermore, by mounting the imaging device provided with the image coding apparatus 10 on any type of mobile objects such as, for example, automobiles, electric vehicles, hybrid electric vehicles, motorcycles, bicycles, personal mobility, airplanes, drones, ships, robots, construction machinery, or agricultural machinery (tractors), images can be efficiently recorded or transmitted to external devices. Moreover, by providing an image processing apparatus of the present technology in a portable electronic device having a function of capturing a moving image, it becomes possible to reduce an amount of data as compared with a conventional one, when recording an image on a recording medium.

The series of processing described in the specification can be executed by hardware, software, or a combined configuration of both. In a case of executing processing by software, a program recorded with a processing sequence is installed and executed in a memory incorporated in dedicated hardware in a computer. Alternatively, the program can be installed and executed on a general-purpose computer that can execute various processes.

For example, the program can be recorded in advance on a hard disk, a solid state drive (SSD), or a read only memory (ROM) as a recording medium. Alternatively, the program can be stored (recorded) temporarily or permanently, in a removable recording medium such as a flexible disk, a compact disc read only memory (CD-ROM), a magneto optical (MO) disk, a digital versatile disc (DVD), a Blu-Ray (registered trademark) disc (BD), a magnetic disk, or a semiconductor memory card. Such a removable recording medium can be provided as so-called package software.

Furthermore, in addition to being installed on a computer from a removable recording medium, the program may be transferred to the computer in a wired or wireless manner from a download site via a network such as a local area network (LAN) or the Internet. In the computer, the program transferred in such a manner can be received and installed on a recording medium such as an incorporated hard disk.

Note that the effects described in this specification are merely examples and are not limited, and additional effects that are not described may be present. Furthermore, the present technology should not be construed as being limited to the embodiment of the technology described above. The embodiment of the present technology discloses the present technology in the form of exemplification, and it is obvious that those skilled in the art can modify or substitute the embodiment within the gist of the present technology. In other words, in order to determine the gist of the present technology, claims should be taken into consideration.

Furthermore, the image processing apparatus of the present technology can also have the following configurations.

(1) An image processing apparatus including:

a line buffer number calculation unit configured to calculate a number of line buffers on the basis of level information and input image information; and

an intra-prediction unit configured to perform intra-prediction processing by using a line buffer of a number of line buffers calculated by the line buffer number calculation unit.

(2) The image processing apparatus according to (1), in which a coded stream generated by using a prediction result of the intra-prediction unit includes the level information and the input image information.

(3) The image processing apparatus according to (1) or (2), in which the coded stream includes identification information that enables identification as to whether intra-prediction processing is intra-prediction processing using a buffer of the calculated number of line buffers or intra-prediction processing using a line buffer of one line.

(4) The image processing apparatus according to any one of (1) to (3), in which the intra-prediction unit performs downsampling processing on a luminance component in cross-component linear model prediction, with a number of filter taps according to a number of line buffers calculated by the line buffer number calculation unit.

(5) The image processing apparatus according to any one of (1) to (4), in which the line buffer number calculation unit calculates the number of line buffers by using a tile horizontal size at a time of tile division.

(6) The image processing apparatus according to any one of (1) to (5), further including

a deblocking filter configured to perform deblocking filter processing on decoded image data, in which

the deblocking filter uses a line buffer of a number of line buffers calculated by the line buffer number calculation unit, to perform the deblocking filter processing with a number of filter taps according to the calculated number of line buffers.

(7) The image processing apparatus according to any one of (1) to (6), in which the line buffer number calculation unit uses a maximum screen horizontal size calculated on the basis of a maximum number of in-screen pixels corresponding to a level indicated by the level information, and uses an input image horizontal size indicated by the input image information, to calculate the number of line buffers.

(8) The image processing apparatus according to any one of (1) to (7), in which, when the intra-prediction unit performs intra-prediction for a line at a CTU boundary, the intra-prediction unit uses decoded image data held in a line buffer of the calculated number of line buffers to determine an optimum intra-prediction mode.

(9) The image processing apparatus according to any one of (1) to (8), in which the line buffer number calculation unit calculates the number of line buffers by using a maximum screen horizontal size stored in advance, in place of the input image information.

(10) The image processing apparatus according to any one of (2) to (7), in which the intra-prediction unit uses decoded image data held in a line buffer of the calculated number of line buffers, to generate a prediction image in an optimum intra-prediction mode indicated by the coded stream.

### REFERENCE SIGNS LIST

10 Image coding apparatus
21, 69 Screen rearrangement buffer
22, 33, 66 Arithmetic unit
23 Orthogonal transformation unit
24 Quantization unit
25 Reversible coding unit
26, 61 Accumulation buffer
27 Rate control unit
31, 64 Inverse quantization unit
32, 65 Inverse orthogonal transformation unit
34, 67 Deblocking filter
35, 68 SAO filter
36, 71 Frame memory
37, 72 Selection unit
38, 63 Line buffer number calculation unit
41, 73 Intra-prediction unit
42 Inter-prediction unit
43 Prediction selection unit
50 Image decoding apparatus
61 Accumulation buffer
62 Reversible decoding unit
74 Motion compensation unit
411 Intra-mode search unit
412 Prediction image generation unit
4111 Control unit
4112, 4121 Buffer processing unit
4113 Prediction processing unit
4114 Mode determination unit
4122 Image generation processing unit

1. An image processing apparatus comprising:
a line buffer number calculation unit configured to calculate a number of line buffers on a basis of level information and input image information; and
an intra-prediction unit configured to perform intra-prediction processing by using a line buffer of a number of line buffers calculated by the line buffer number calculation unit.

2. The image processing apparatus according to claim 1, wherein
a coded stream generated by using a prediction result of the intra-prediction unit includes the level information and the input image information.

3. The image processing apparatus according to claim 2, wherein
the coded stream includes identification information that enables identification as to whether intra-prediction processing is intra-prediction processing using a buffer of the calculated number of line buffers or intra-prediction processing using a line buffer of one line.

4. The image processing apparatus according to claim 1, wherein
the intra-prediction unit performs downsampling processing on a luminance component in cross-component linear model prediction, with a number of filter taps according to a number of line buffers calculated by the line buffer number calculation unit.

5. The image processing apparatus according to claim 1, wherein
the line buffer number calculation unit calculates the number of line buffers by using a tile horizontal size at a time of tile division.

6. The image processing apparatus according to claim 1, further comprising:
a deblocking filter configured to perform deblocking filter processing on decoded image data, wherein
the deblocking filter uses a line buffer of a number of line buffers calculated by the line buffer number calculation unit, to perform the deblocking filter processing with a number of filter taps according to the calculated number of line buffers.

7. The image processing apparatus according to claim 1, wherein
the line buffer number calculation unit uses a maximum screen horizontal size calculated on a basis of a maximum number of in-screen pixels corresponding to a level indicated by the level information, and uses an input image horizontal size indicated by the input image information, to calculate the number of line buffers.

8. The image processing apparatus according to claim 1, wherein
when the intra-prediction unit performs intra-prediction for a line at a CTU boundary, the intra-prediction unit uses decoded image data held in a line buffer of the calculated number of line buffers to determine an optimum intra-prediction mode.

9. The image processing apparatus according to claim 1, wherein
the line buffer number calculation unit calculates the number of line buffers by using a maximum screen horizontal size stored in advance, in place of the input image information.

10. The image processing apparatus according to claim 2, wherein
the intra-prediction unit uses decoded image data held in a line buffer of the calculated number of line buffers, to generate a prediction image in an optimum intra-prediction mode indicated by the coded stream.

11. An image processing method comprising:
calculating, by a line buffer number calculation unit, a number of line buffers on a basis of level information and input image information; and
performing, by an intra-prediction unit, intra-prediction processing by using a line buffer of a number of line buffers calculated by the line buffer number calculation unit.
